(19) United States
(12) Patent Application Publication
(10) Pub. No.: US 2021/0374563 A1
(43) Pub. Date: Dec. 2, 2021

(54) Solution Automation

(71) Applicant: Joni Jezewski, San Ramon, CA (US)

(72) Inventor: Joni Jezewski, San Ramon, CA (US)

(21) Appl. No.: 16/887,411

(22) Filed: May 29, 2020

(51) Int. Cl. G06N 5/04; G06F 9/451; G06Q 10/10; G06N 20/00; G06F 40/247; G06F 40/166; G06F 40/30

(52) U.S. Cl. CPC G06N 5/04; G06F 9/453; G06Q 10/10; G06F 40/30; G06F 40/247; G06F 40/166; G06N 20/00

(57) ABSTRACT

This invention translates a problem definition into a structure that allows for resolution of the structure into the corresponding solution format with a set of queries (formatted as a query of the interface network—a set of standardizing filters applicable to format information in way that it can be analyzed with interface-specific logic, which may also be a problem-solving automation workflow, if problems can be solved with the format sequence indicated by the interface traversal).

### FIELD

Embodiments of the disclosure relate to automation of problem-solving for clearly defined problem statements using interface analysis.

### BACKGROUND

Problem-solving is usually done manually, without context about prior solutions, common solutions, or a way to graph the standardized problem & solution, or a systematic method to translate them into other standard formats that are more amenable to being matched using standard structural operations like map, filter, combine, etc.

Any prior art relating to mathematical methods of solving problems or a protocol to generate solutions would be outputs of this invention, or stored in the database component of this invention as a prior identified solutions for a problem type, with associated intents, insights & other information relating to the solution.

### SUMMARY

One or more embodiments of the present disclosure may include a method that includes obtaining a problem statement from a user including required solution metrics (such as priorities, functionality, or attributes); identifying problem & problem space metadata (such as problem type & minimum information required to solve the problem); identifying optimal origin interface to start traversing from, interface traversal sequence, & applying interface operations like combine/inject; traversing interface network (including interfaces such as information, insight, structure, math, concept, type, variance, potential, change, intent, perspective, system, attribute, pattern, function, cause, problem/question, solution/answer) of interfaces acting as filters (where an interface is comprised of its definition routes, conversion function, core functions, objects, & attributes, and related objects like patterns & metadata specific to the interface) starting at the origin interface; finding components on the interface that match the problem structures (including related objects like insights, patterns, & functions); compressing the problem statement into its most accurate structure containing the found interface objects; iterating the origin interface selection & interface traversal process for the solution space; identifying & reducing the solution space from this standardized problem format; traversing subsequent interfaces to obtain additional information; reducing the solution space by the problem & problem space definition; returning the identified optimal solution as a set of steps to compress the problem as well as solution metrics, attributes, & actions, and/or insights/patterns/system/standardized description related to the problem if no solutions are found.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 User Interaction Module 110 is a diagram of an example user interface implementation to gather input about a problem & program configuration for Solution Automation Module 140.

FIG. 2 Solution Automation Module 140 is a diagram of example components (such as functions & constants) of a program to automatically find/derive/generate a solution for a problem, to implement the general execution workflow of FIG. 4.

FIG. 3 Machine learning system 120 is a diagram of an example wrapper component that would call a machine learning system to predict a variable.

FIG. 4 API finding/calling system 130 is a diagram of an example wrapper component that would call an API finding/calling system to retrieve data.

FIG. 5 Solution Output 150 is a diagram of an example output of the process in FIG. 4 that could be displayed & edited in the User Interaction Module 110.

FIG. 6 Finding matching interface & problem components is a diagram of an example of determining possible match between the problem system intersection object and the system conflict object.

FIG. 7 Applying matching interface components to problem system is a diagram of an example of converting & applying matching interface objects back to the problem system.

FIG. 8 Applying solution metric structures to solution structures is a diagram of an example implementation of filtering the solution space with solution metrics.

FIG. 9 Subset of Conflict Object is a diagram of example structures forming the definition routes of an example system object on the structural interface. An example of a definition route is documented here: https://github.com/outdreamer/build-a-cure/blob/52c3461fdd3ff38284b63f8c2e71542f415d88d9/find_exisiting_solutions/system_analysis/maps/definition_routes.json

FIG. 10 General Workflow is an overview of an example process 100 for implementing problem-solving automation workflows, from initial problem formatting to solution matching to solution application & analysis.

FIG. 11 is a diagram of an example computing system 300.

### DETAILED DESCRIPTION

As used herein, terms used in claims may include the definitions:
interface: a useful standard for comparison consisting of the filtering object's definition routes, conversion function, core functions, objects, & attributes, and related objects like patterns & metadata specific to the interface. Abstract interfaces include cause, concept, structure, etc, whereas specific interfaces are other foundations where change develops in a clearly defined range that can be found in specific systems. The traversal of an interface implies finding a map between objects, functions, & attributes inherent to that interface to the problem objects, functions, & attributes. The application of an interface is an operation in an interface combination, mapping, injection, or other operation.
function: a set of inputs, a sequential list of rules or rule lists (logic tree) applied to the input set, an output set created by changes to the input set executed by the sequential rule list, optionally including side effects from execution. A function may be formatted in a different way, such as a list of attributes, filters, or a network. The function definition includes:
example functions are documented here: https://github.com/outdreamer/build-a-cure/blob/52c3461fdd3ff38284b63f8c2e71542f415d88d9/find_exisiting_solutions/system_analysis/maps/definition_routes.json
attributes:
   alignment: enforced/optional, core, required, emergent/output (built from core functions, with or without associated intent)
   interaction: cooperative/conflicting
   intent: generative, filtering, grouping, organization/delegation/distribution/matching/grouping/filtering, classification, differentiation/transformation
   scope: use case, context, range, host system
   related objects (like host spaces/systems & object positions in those)
   types:
      core functions
      meta (rule-modification/generation rules)
      attribute rules (state, scope)
      interaction rules (competition, binding, combination, sharing, collaboration, intersection, conflict resolution, trade rules)
      assessment rules (metric, difference, definition, validation)
      processing rules
      change rules (update, distortion, maintenance, adjacency, conversion)
      filtering rules (find, identify, define, alternate, organize, learn)—matching rules (fitting a structure, filling a structures)
      application rules (inject, embed, apply)
      derivation rules (structure, navigate, abstract)
      decision rules (prioritize, select, compare)
      formatting rules (standardize, isolate, cluster)
      destruction rules (replace, invalidate, neutralize, remove, merge, de-duplicate)
      government rules (monitor, correct, enforce, maintain, stabilize)
      system rules (incentives, variance handling, optimization)
      interface rules (change, intent, type, pattern, concept)
      info rules (problem, strategy, insight, game, perspective)
      variance (injection, leaks, combination, replacement, causal direction, uncertainty, risk, potential, probability, prediction) rules
      information handling (storage, versioning, replacement, merging, monitoring, indexing, communication, interpretation, processing)
      solution rules (variance/stressor/error detection, tracing, identification & handler)
      structure rules (gap, boundary, system, limit, hub, object, link, network, filter)
intent: any of an abstract goal with direction, a reason to use something, or an output such as the intended result or an unintended side effect, which can be an abstract priority like fairness, a concrete goal, and can have a starting & ending position.
game: a set of intents/alternatives/limits/incentives/exploits/rules/risk & a definition of distance from intent fulfillment (position), usually resulting in the resolution of a clearly optimal route. The game definition includes:
   a game is a type of system & a mixed set, which can exist as a component of a system
   games can have many different structures like:
      a directed graph with a vector set representing possible agent intents/functions/resources
      a system of nodes & links where agents need function input resources to traverse
      a decision tree where certain tree info becomes accessible only at certain nodes (adding uncertainty/risk)
      a set of trade options between nodes with different info change/update rules in a system to optimize a resource/trade/market metric
concept: set of unique objects remaining once objects from other spaces have their context & contradictory attributes removed. For example: power is the object left when objects implementing it: resources=>energy=>input=>potential) have their context removed, navigating up the abstraction stack from:
   the info layer (resources & energy), removing their contextual attributes/rules—to the abstract structural layer (input)
   to the abstract layer (potential, which is a related concept of power)
   so that the final object is defined in terms of other abstract objects on the top layer
problem: may include any context or condition that causes a negative position or state determined by a metric for an agent in a system. The problem definition includes problem types:
   dependency
   leaks (variance, resource/info)
   injection (assumptions/variance/control/randomness)
   mismatches
   conflicts
   imbalances
   inefficiencies
   complexity
   incorrect metric
   misidentification
   gaps
   limits
   side effects: whether it's a closed system or leaks variance
      function side effect example:
         before execution: pre-computing
         during: memory access/overflow
         after: process re-starting
   specific problems:
      enforcement gap (should have enforced rule but did not)
      unintended use (involves integrated third party tech not under review)
      malicious alternative route to get same output
      legitimate/alternative route to get malicious output
problem space: context relevant to a problem; the containing system(s) of a problem that may include related problems
solution: may include any combination of events, methods, or steps that reduces the negative position or state for the specified agent. The solution definition includes solution types:
   solution-metadata solution: evaluating & comparing solution metadata for solution selection
   problem-metadata solution: evaluating problem metadata to evaluate metrics like problem-solving postponement
   generative solution: solution that generates solutions
   solution framework: provides starting point & structures for solutions to be built in/with
   problem decomposer: solution that reduces a problem's root causative (as opposed to just varying) parameters
   solution automator: solution that automates solutions of a type
   interim solution: clearly suboptimal solution while optimal alternative is built
   solution query constructor: solution that builds new solutions out of known solution types (existing structural solutions or core functions)
   structure-finding solution: solution that assigns a structure to information
   structure-fitting solution: solution that matches the gaps/limits in a problem structure to neutralize them
solution space: set of possible solutions in a problem space, which may be reduced by applying interface traversals like solution space-reducing insight paths
network: standard network graph containing nodes (sometimes called vertices) & linking functions (sometimes called edges), with or without node attributes, function relationship determining function shape, and direction as an indicator of intent or another metric.

Method described in claims includes:

1. obtaining a problem statement from a user including required solution metrics (such as priorities, functionality, or attributes)

2. identifying problem & problem space metadata (such as problem type & minimum information required to solve the problem)

3. identifying optimal origin interface to start traversing from, interface traversal sequence, & applying interface operations like combine/inject

4. traversing the interface network (including interfaces such as information, insight, structure, math, concept, type, variance, potential, change, intent, perspective, system, attribute, pattern, function, cause, problem/question, solution/answer) of interfaces acting as filters (where an interface is comprised of its definition routes, conversion function, core functions/objects/attributes, and related objects like patterns & metadata specific to the interface) starting at the origin interface

5. finding components on the interface that match the problem structures (including related objects like insights, patterns, & functions)

6. compressing the problem statement into its most accurate structure containing the found interface objects

7. iterating the origin interface selection & interface traversal process for the solution space

8. identifying & reducing the solution space from this standardized problem format

9. traversing subsequent interfaces to obtain additional information

10. reducing the solution space by the problem & problem space definition

11. returning the identified optimal solution as a set of steps to compress the problem as well as solution metrics, attributes, & actions, and/or insights/patterns/system/standardized description related to the problem if no solutions are found

12. if solutions are found, compare solutions with filters, risk contribution, & problem space visualization

System described in claims wherein the matching of a problem and a solution is done with various interface traversals, potentially determined by the selected origin of the traversal, problem & solution & space definitions, including:
system interface traversal (fitting of system objects like symmetries, sub-systems, sub-interfaces, false assumptions, correlations, and conflicts to problem definition)
information interface traversal (with logic such as mapping the problem as a combination/set/path containing information problem types like an information mismatch or inequality or minimum or overflow or lack)
insight path application (using insight paths from other fields to optimize insight generation)
problem vectorization (mapping the problem definition to a one-directional tree with inputs on one side, interim inferred important problem concepts in between, and target priorities or attributes on the other, linked by available functions)
concept-structure traversal (a multi-interface traversal linking the concept & structure interfaces, so a target concept combination/set/path or target structural attribute can be achieved with a combination of filters & limits or functions applied to adjust the structure until it matches the target structural attributes or concepts)
a pattern interface traversal (where patterns replace missing required data, such as patterns between variables of specific types or system positions to infer their probable relationship)
a causal interface traversal (where the problem structures are matched to causal structures to infer probable causation metadata like directness of cause, degree of cause, inevitability, uniqueness of cause, causal tree/network/loop/layer shape)
structure-math interface mapping (a multi-interface traversal to map problem structures to math objects to apply math insights to problem structures)
a question-answer interface traversal (where a question defined as missing information is framed as a source position and a target position on a network, and the answer is the most robust path or the path that moves the nearest to the target position or the path that moves in the priority direction on the network)
problem space analysis (given whether the problem space changes in a way that invalidates the original or other problems once a particular solution is applied, and selecting between solutions)

The present disclosure relates to the use of interfaces & custom logic automation for constructing a solution automation system. A combination of the core structures referenced or general mathematical objects, functions, or attributes may be used to graphically visualize:
a problem space depicted as a set of boundaries indicating limits creating the problem space (like limited tech creates a problem space)
the problem space dimensions maximizing variance between related problems—a network of related problems in the problem space & their state
the origin problem occupying a position on the problem network, which can be represented differently according to the type & the solution generation method, for example:
   if the user's problem object is represented as a 3-d shape like a cube (indicating it has three main variables expanding each other from an origin corner & forced to create a closed system to maintain state, or 6 limits interacting with each other but not overlapping), the solution would need to be in a vector format to remove dimensions of the shape or reduce the size of the problem shape
   if the user is representing their problem on the information interface, they may want to represent it as an information problem type within a system context, like how:
      a conflict between system incentives & agent intents could be represented as two vectors with the same origin or two vectors going in different directions
      an information imbalance would look like extra information in different positions
      an information asymmetry would look like information in a position where it's not needed & can be exploited to charge rent
      an information market would have some trust structures embedded so information can be bought instead of derived for conveniences, similar to how concepts like delegation would look like a node sending calls to other nodes that run tasks & return response data
problem types have structure once they're framed as an information problem, and once concepts are converted to more structural interfaces, they also have default structural forms reflecting their definitions
the solution space for the origin problem (and for all related problems on the network that the solution space applies to), where the solution space is a reduced version of the problem shape or structure or the set of possible solutions
solutions to the origin problem, represented as:
   a subset of the problem shape (like a path answering a question, where the solution space is all possible routes between origin & destination nodes)
   a structure within a system containing the problem (an optimal route with a required attribute like efficiency, or a combination of objects reducing variance in a rule gap, or a filter sequence that creates a function optimally while storing minimal code)
   a structure (other than reductions) to aim for when transforming the problem and the available resources implied in its definition (a solution defined as an optimal version of the problem structure, like the optimal structure to represent a concept)
   a compressing transform of the problem shape (solution vectors removing problem dimensions until it's a point)
the impact of solutions on the problem network or the origin problem (depending on the problem & solution format as stated above)
the expansion & compression of embedded objects (such as problems, solutions, systems, concepts, and interfaces which change on other dimensions than the problem space dimensions) to the embedded graphs in the problem space using vectors
alternate versions of the problem space with other attribute sets as dimensions, to isolate impact of a solution on other attributes
concepts having structure in a problem space depending on the context determining that space
   example of structure applied to a concept: dependence is a form of the power concept with nodes running tasks for a powerful node
interfaces represented as a filter converting objects to a foundation where vector sets representing different unit core functions of change possible on that interface (where core interface functions are depicted in embedded graphs or adjacent converted graphs of a problem space, and including a function to convert other objects to combinations of the vectors in that interface's vector set
   example: converting objects to the type interface involves identifying attribute sets that are unique, and then identifying types that can describe multiple unique objects as variations of an attribute in the attribute set.

A problem-solving effect may be measured based on whether a solution contains or comprises a vector that:
neutralizes a problem vector
reduces the problem shape size
removes a problem dimension or variable
does any combination of the above for the origin problem & related problems, potentially neutralizing the problem space itself or converting it to another problem space.

This system enables the identification of solution spaces, solution sets achieving different solution metrics within the solution space, and may also identify optimal solutions for a particular problem, problem type, or problem network in a particular problem space. This enables the automation of finding solutions that optimize specific solution metrics defined in a problem statement in a discoverable system (where relevant system objects can be described, core system functions can be derived, solutions can be tested, & success can be measured with some metric & threshold or target value). This enables arriving at insights sooner, building products optimally sooner, inventing products sooner, and predicting patterns sooner, with less data & computational capacity.

This system relies on the dependencies:
a database including tables to store found associations & objects in queries, as well as tables storing data sources & solution sources, as well as standard objects & their metadata (such as definition routes & conceptual queries) following the schema specified in my repository: https://github.com/outdreamer/build-a-cure/blob/52c3461fdd3ff38284b63f8c2e71542f415d88d9/docs/objects/schema.md
an example of an object definition includes attributes like:
   core spaces: default sets or other structures where this object can develop—core structures (points, filters, limits, boundaries)
   core objects
   core functions
   dependencies: required objects or alternative object sets that can build this object
   optimization potential
   conceptual attributes (completeness, relevance, randomness, importance, complexity, reusability, independence, modularity)
   abstraction: abstraction level should reduce misunderstandings while optimizing reusability
   automation potential (resource investment, rule stabilization)
   applicable definitions (like for equivalence)
   minimum object identification information (required identity attributes)—relationships
   adjacent/related objects of same/different type
   problems with adjacent objects & how those problems are generated by adjacent object metadata
   order/position in chains & networks of this type
   interface queries that can produce this object
   related interface objects (problems, questions, strategies, insights, perspectives, filters, intents, concepts, patterns, structures, functions, types, incentives, assumptions, limits, state, problems, potential, games)
   context (use cases, extreme cases, examples)
a graphical user interface (GUI) providing inputs to provide problem statement, solution metrics & other metadata described below
logic including:
   a set of definitions, set of core objects, and a set of functions (converting, filtering, applying core interface functions, traversing interface network) for each interface
   a set of functions to select filters to display in the GUI, and validate input (for example, if the problem statement doesn't match problem type specified)
   a set of functions to convert a problem statement (and problem space context if provided) into the problem object metadata
   a set of functions for core operations like:
      find (function to apply filters to a structure)
      build (function to assemble components given a particular definition of combine)
      derive (function to identify possible paths, compare them, and select one given a solution metric)
      change (function to apply an object, function, or attribute to another)
      define (function to identify & define attributes, functions, & objects (given minimal information like their position in a system or their set of attributes compared to other system objects))
   a set of utility functions, including:
      a function to convert an object between formats (function=>attribute sequence, function=>filter sequence, etc) by mapping attributes & functions & other metadata of the objects & removing attributes that don't fit in the target format definition (for example, if the user is converting to a type, the output should be in an attribute set format)
      a function to identify structure matching a pattern (like identify a structure embodying a mismatch, which is a problem type, given a system network definition, where the system could represent an object, function, or attribute)
      a function to identify sub-components or system context of a component (a component which could be either a function, object, or attribute)
   a set of graphing functions
      to graph the problem space, problem, related problem network, solution space, solution, embedded graphs, interfaces, and other relevant objects
   a set of problem & solution functions
      a set of functions to evaluate & select between comparable solutions, including selecting solutions based on input preferences selected (avoid using ML in solution, use a particular interface, use pre-computed solutions, etc)
      isolate the solution space in the problem space
      break the problem space into sub-problems that can execute their own interface traversal & solution-matching process to find sub-solutions
      reduce the solution space
      apply the solution to the problem space
      a function to check if a solution reduces a problem or fulfills a solution metric
      a function to check if a solution fits a structure such as input assumptions & limits
   a set of specific functions for each interface, for example:
      intent: a function to derive intent as a dependency of the intent interface conversion function
      core: a set of functions to generate the set of possible combinations in an interaction space to conduct core combination analysis & identify probable important objects like an incentive would be identified as an important system object given the system filters it passes after being generated by core combination analysis)
      type: a function to identify the type an object belongs to, given its metadata
      system: a function to identify system objects given their definition, such as a variance gap (a gap in rule enforcement)
      concept: a function to identify concepts given their definition & a system network (either structures applies to abstract concepts—or useful combinations of objects, functions, & attributes that are causative or interfaces in a system)
   a set of functions to analyze prior queries, optimize & maintain the program, such as:
      removing duplicates
      analyzing solution statistics
      optimizing an interface traversal once found
      pre-computing & storing frequently requested traversals
      optimizing data storage & logic given how other users are using the program

A standard workflow for this system may involve:
inputs:
required:
   the problem statement
   the interface definitions
   logic functions to traverse interfaces, visualize the impact of a solution on the problem/problem space, & test for adherence to a solution metric, check input for validity
optional:
   the problem space context, without which the program will make API calls to fetch data & definitions (including data like alternate definition sources, object behavior rules, latest version of an open-source solution
process:
   database storing example objects (example insights, problems, solutions, questions, patterns, functions, causes, concepts, types, systems, etc), as well as previous queries if configured to do so
   process 100 executed, conditionally making calls to the machine learning system and the API finding/calling system if predictions, data, or definitions are needed
outputs:
   solution information, including any of the following:
   a particular solution implementation of a strategy
   a solution set of solutions that were not reducible given input filters
   a solution space identifying that a solution is possible in the problem space
   a set of information objects about the problem, problem network, or problem space that clarify the problem to some degree, such as causes deemed not likely or additional problem metadata derived or a problem-invalidating event identified

One or more example embodiments are explained with reference to the accompanying drawings.

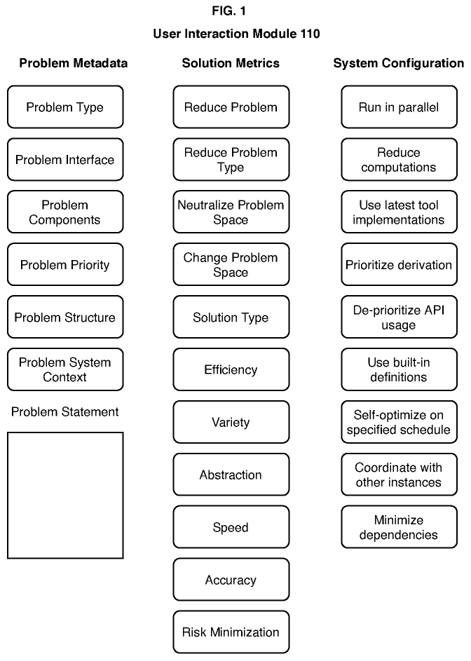

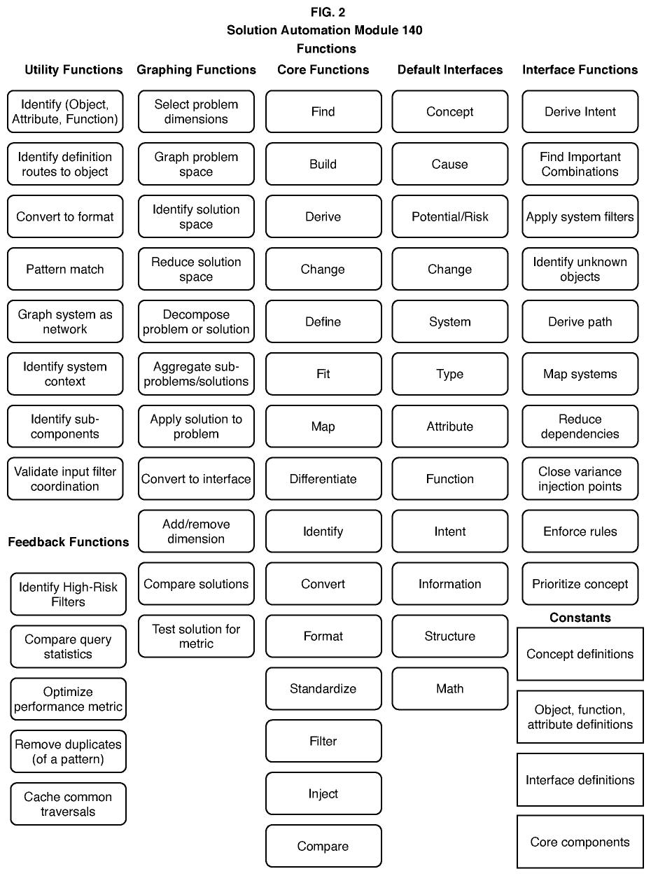

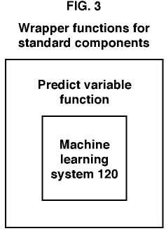

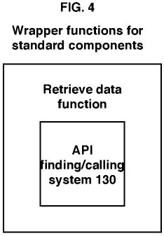

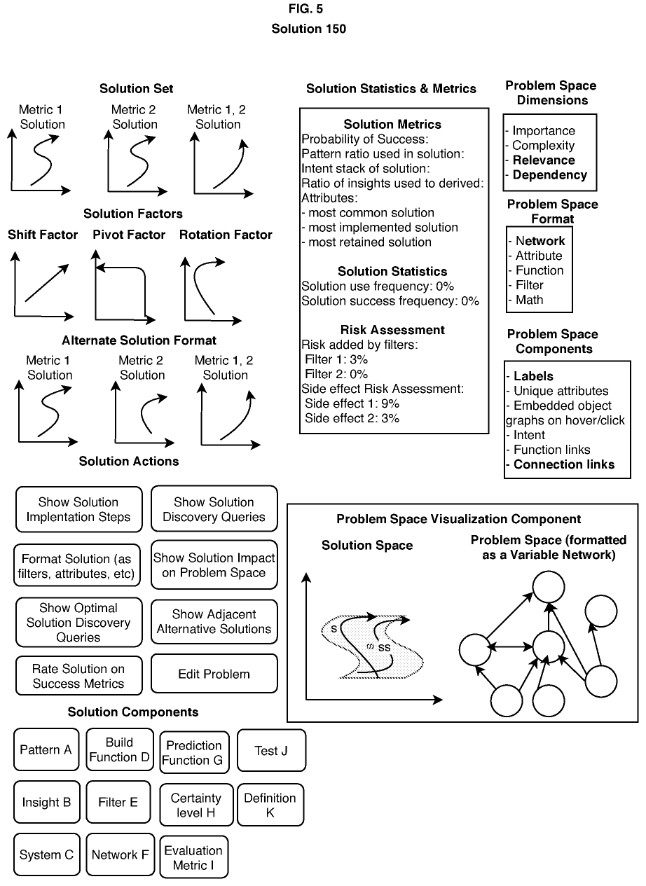

FIG. 1 is a diagram illustrating an example system 100 that may be used to automate finding a solution for a problem statement, in accordance with one or more embodiments of the present disclosure. The system 100 may include a user interaction module 110 and a machine learning system 120 (as shown in FIG. 3) and an API finding & calling system 130 (as shown in FIG. 4) that may provide input to a solution automation module 140 (as shown in FIG. 2). The solution automation module 140 may facilitate determination of the solution 150 (as shown in FIG. 5) associated with the problem statement, and output the solution 150 to the user interaction module 110.

In some embodiments, such solution automation may lead to a solution for the problem, such as the cause of a problem, the intents fulfilled by a problem and/or the solution, a set of steps to reduce the problem, or a set of steps to neutralize or change the problem space containing the problem. In these and other embodiments, if a user is dissatisfied with the provided solution 150 (e.g., the solution is incomplete or no solution was found), the user may interact with the system 100 (e.g., to add more information or remove assumptions) and the solution automation may be run again.

The machine learning system 120 may include any machine learning system configured to identify relationships and/or correlations from a data set. For example, the machine learning system 120 may be configured to identify a set of most likely factors contributing to a problem or sub-problem or solution, whether directly or indirectly, by analyzing data sets. As an example, the machine learning system 120 may analyze all solution examples and predict which solution would be the best implementation for a problem definition, or analyze all sub-problem & problem associations stored in the database & predict which sub-problems would be the best way to break down a problem, or analyze all previous queries on the solution automation module 140 and predict which factors will be used the most as inputs to show on the user interface module 110 (in the absence of functions on interfaces described above, or if machine learning is specified as a preferred solution method on the user interface module 110 before running the solution automation module 140). In these and other embodiments, the machine learning system 120 may provide the correlations and/or the factors contributing to an input to the user interaction module 110 and/or the solution automation module 140.

In some embodiments, the machine learning system 120 may operate using any machine learning technique or deep learning technique, such as decision tree learning, association rule learning, clustering, reinforcement learning, representation learning, genetic algorithms, etc. In some embodiments, the machine learning system 120 may be utilized to perform a task, such as providing a recommendation of input filters to show in the user interface module 110 based on previous queries of the solution automation module 140.

The user interaction module 110 may include any device or system or components thereof configured to receive user input and/or provide information to the user. For example, the user interaction module 110 may present an input to enter the problem statement and a set of filters (to refine the problem statement, or attach problem and/or problem space metadata such as expected complexity, known problem sub-problem, known problem factor, or preferred problem definition) as well as an input for common & other solution metrics (such as solution-finding time/cost, solution-implementing time/cost, accuracy, using pre-computed solutions or deriving solutions from scratch, using a particular data source for definitions & other API calls inserted into the workflow rather than using system-generated data sources from the initial or previous queries, etc) to a user. In these and other embodiments, the user may utilize the user interaction module 110 to identify problem & problem space metadata & solution metrics as an input filter to reduce the solution space and evaluate output solutions. In these and other embodiments, the user may additionally utilize the user interaction module 110 to identify output solutions of varying types (including optimal, low-cost, reusable, able to reduce other problems, able to invalidate a problem space, able to change a problem space to a very different one, etc) to create a score to store the output in the database as a solution (if the score is high) or a problem (if the score is low) associated with the origin problem statement. For example, the user may designate an output solution as optimal for solving a sub-problem of the origin problem, and the database will store a link between the sub-problem and the output solution as one of the sub-problem's optimal solutions.

The solution automation module 140 may include any device or system or components thereof configured to utilize the inputs from the machine learning system 120 or the API finding & calling system 130 and from the user interaction module 110 to output the solution 150.

In some embodiments, user input may vary, such as where the problem statement may be an abstract statement, a statement about a problem type, or missing necessary information. The output may be incomplete or otherwise sub-optimal, in which case the user can state the problem differently or add information or their own theory about the cause or solution, or expand the allowances of the configuration to include more pattern & derivation computations than more direct problem-solving methods or pre-computed solutions that may need updating. The problem statement validation will return a message if the program cannot correct the problem statement or return a validation question to prompt the user to enter specific information. Deriving problem metadata such as the minimum information to solve a problem or deriving solution requirements would take the form of logic such as identifying required probable solution structures necessary to solve the problem & information necessary for filtering solutions in that format or for a particular intent (if it's a shape, the solution needs to be in vector format and the dimensions need to be identified). The validation will also validate other input fields like problem metadata, so that a problem statement that doesn't match the specific problem type will return an error indicating that mismatch.

In some embodiments, the user may want to use alternate data sources for the definitions & object metadata, or use data sources rather than deriving information, in which case API finding/calling functionality will be executed to discover public or permitted data sources matching target objects, or the data can be generated (or the definition predicted) using a standard machine learning model. Similarly these standard methods can be used to retrieve or generate the latest implementation or pre-computations for a solution or utility function (like sorting or indexing algorithms or testing tools), when local assets are compromised or when the user sets a preference for crowd-sourced or new tools.

In some embodiments, it may not be clear which interface should be the origin interface, in which case multiple processes can be run if allowed by user configuration (for example, if they selected ‘performance’ as a metric to optimize, meaning the user requests a quick solution, multiple parallel processes wouldn't be allowed), and may periodically stop and check if the other process has useful information or is nearer to the solution, at which point the slower process can stop.

In some embodiments, alternate default core interfaces may be selected than the abstract interfaces such as function, system, type, etc. Some embodiments may organize these interfaces by type, so that function/pattern/insight/strategy are all stored as sub-interfaces of the rule interface, and the same for information/structure/math being related interfaces with minor transformations.

In some embodiments, alternate implementations of the functions may determine the system functions such as:
visualization of problem space & problem dimensions, composition, & solution application
utility functions like identifying unique & conceptual attributes given a system definition
high-level logic functions like determining whether a solution reduced a problem or achieved an intent

In some embodiments, alternate default interface trajectories may be determined to be optimal using analysis of previous queries run on the solution automation module, if the user configures the program to self-optimize in the GUI, such as starting from an interface that generally solves the problem of a certain type more quickly, which is determined by querying the insight table pre-traversal once the problem type is identified, as opposed to searching for new solutions or optimizing known solutions for that problem type, or converting problems to a problem type with many known solution methods, like a route optimization problem.

In some embodiments, solutions that optimize metrics not specified by the user may be included in the output, such as solutions optimizing the user-specified solution metric and metrics that impact other problem-solvers, like the environment. For example, even if a user didn't request clean energy solutions for their traversal to find the optimal implementation of a Air Conditioning unit, the program may still return energy-conserving solutions like automatically shutting itself off when target temperature is reached, given that this energy-conserving solution optimizes more metrics than the requested solution, or that other users preferred the energy-conserving solution metric, or that the program identified energy-conserving solution metrics as conserving available resources, which would not only improve cross-system design for many agents using the program but also increase the likelihood that the program would have energy to run parallel processing or large queries or self-maintenance & self-optimization logic.

In some embodiments, after being presented with the solution 150, the user may be dissatisfied with the solution 150. In these and other embodiments, the user may modify or adjust one or more of the input filters provided to the solution automation module 140 regarding the problem/problem space/solution metadata derived and the origin interface & the formats selected for the problem-solution matching process.

For a prediction function problem, the solution space is the range of likely prediction functions. The problem space is the route between independent variables and the dependent variable on a network—it can also be framed as the route between common prediction function terms for a data set like the input data set, and the prediction function. The original problem structure is also depicted as a subset of this problem space visualization. The solution function can be a route on the problem space if the problem space is formatted as a network, for example.

By iteratively repeating the process of adjusting the input filters by the user, the solution automation module 140 may repeatedly generate different solutions 150 until the user is satisfied with the solution 150. In some embodiments, the user may be dissatisfied with the solution based on preference the user has about their preferred optimal solution for the problem statement. In that case, they can add a filter to reduce the solution output, and if the program can find or derive the definition for that metric, it will apply it in the next query. If some metrics or formats contribute to uncertainty in the problem/solution filtering, formatting, compression, interface traversal, or other processes run by the program, the program will return output about the contribution of risky metrics to the uncertainty in the solution output. For example, if the user adds a custom filter like ‘importance’ and the program were to retrieve or derive an over-specific definition such as ‘number of hub connections’, it would cause distortions in the output, which would be included in the report as a risky filter that can be removed. Otherwise the solution may speed up the user's problem-solving process, to identify improvements to a product design, prediction function, or route with just a problem statement.

One skilled in the art, after reviewing this disclosure, may recognize that modifications, additions, or omissions may be made to the system 100 without departing from the scope of the disclosure. For example, the designations of different elements in the manner described is meant to help explain concepts described herein and is not limiting. Further, the system 100 may include any number of other elements or may be implemented within other systems or contexts than those described.

Different traversals are associated with different starting information and/or different problem type and/or different solution intent. For example, framing a problem on the change interface may help predict how the problem will change better than framing it on other interfaces. The system wherein the matching of a problem and a solution is done with various interface traversals, potentially determined by the selected origin of the traversal, problem & solution definitions & associated space definitions, including:
system interface traversal
   general: fit system objects like symmetries, sub-systems, sub-interfaces, false assumptions, correlations, and conflicts to problem/solution/space definition
   specific: find the lowest-cost path in a system (maximizing the number of efficiencies used) using incentivized paths
information interface traversal
   general: use logic such as mapping the problem as a combination/set/path containing information problem types like an information mismatch or inequality or minimum or overflow or lack
   specific: frame a ‘find a particular record in a data set’ problem as a combination problem of a missing information problem type (composed of a filter-selection problem, an indexing problem, and a sorting problem) or a route optimization problem type (starting point in data set, search/split/sort method selection, and cost-minimization problem for worst-case destination given starting point)
insight path application
   general: use insight paths from other fields to optimize insight generation/identification/derivation, where insight paths can contain questions, strategies, insights, & other information objects that are usable across systems to generate/identify/derive insights in a semi-unknown system
   specific: use insight paths from gene editing to automate inventing by mapping gene editing functions (switch, remove, alter) to inventing problem space functions (switch components, remove assumption, alter variable)
intent interface application
   general: convert inputs/outputs/functions, objects, & attributes to intent to check progress toward solution intent or avoid side effect intents, where adjacent reasons to call the operation & operation outputs are assumed to be included in the intent stack of an operation
   specific: convert inputs/outputs/functions, objects, & attributes to intent, to check progress toward target solution metric or avoid side effects
structural interface application
   general: find a standard structure & format the problem using that structure
   specific: convert functions to standard structures like paths, networks, filters, or attributes to check if a function fulfills a solution metric
core interface traversal
   general: use combinations of core functions (find, build, apply, derive), objects (layer, filter, gap, limit), and attributes (equal, similar) to create a core interaction space & system layer diagram and find target objects quickly using structural definitions of concepts like optimal or applying system filters, or predict missing objects on other layers
   specific: use the core functions of the ‘combine’ or ‘organize’ intent to predict the next generation of products invented
problem interface traversal, specifically a problem vectorization framing the solution as a path in the problem space (mapping the problem definition to a one-directional tree with inputs on one side, interim inferred important problem concepts in between, and target priorities or attributes on the other, linked by available functions)
   general: infer important interim concepts of a problem system (like the ‘duplicate line’ concept for building a ‘merge files’ function) and use intent-mapping to connect stated problem objects & target outputs using available functions
   specific: infer the relevant ‘duplicate line’, ‘similar line’, ‘similar’, & ‘equal’ concepts of a ‘build a function to merge files’ problem system and use intent-mapping to connect stated problem objects (line, file, string) & target outputs (one file without duplicate lines) using available functions (iterate, check, is_similar, is_equal)
concept-structure traversal (a multi-interface traversal linking the concept & structure interfaces, so a target concept combination/set/path or target structural attribute can be achieved with a combination of filters & limits or functions applied to adjust the structure until it matches the target structural attributes or concepts)
   general:
      find a structure for a certain intent that matches a conceptual priority (like relevance, organization, robustness, equivalence, or trust)
      modify a structure with a certain intent so it matches a conceptual priority (like power or a conceptual structure like power distribution)
   specific:
      find a structure in the finance space that minimizes trust in transactions
      modify a multiplication method to find a method minimizing larger calculations
a pattern interface traversal (where patterns replace missing required data, such as patterns between variables of specific types or system positions to infer their probable relationship)
   general: select patterns related to stated objects and traversal for patterns or pattern generators linking them to generate an origin solution space to begin compressions at
   specific: select patterns related to variable relationships & probability distributions to predict the likeliest ways a function will change
a causal interface traversal
   general: match problem structures to causal structures (like tree/network/loop/layer) to infer probable causation metadata like directness of cause, degree of cause, inevitability, ambiguity, uniqueness of cause, causal shape
   specific:
      find the set of causal objects, functions, and attributes describing a relationship to create a prediction function or reduce input features
      apply causal structure relationships to determine if the data is missing information
structure-math interface mapping
   general: use a multi-interface traversal to map problem structures to math objects to apply math insights to problem structures
   specific: if the problem is ‘predict the shape of the boundary of an even distribution of change across directions from the same origin’ (for problems like ‘finding a container needed for an experiment growing microorganisms given the requirement of the same origin and non-overlapping paths’, or ‘predicting the threshold marker needed for comparing speed metrics’), apply the ‘circle’ definition route using the ‘evenly distributed outward motion’ route to infer that the boundary could be circular, with variable advantages depending on problem metadata
a question-answer interface traversal
   general: frame a question as missing information structured as a source position and a target position on a network, and the answer as the most robust path, the most relevant path for a particular intent & objects related to it, the path that moves the nearest to the target position, or the quickest path that moves in the prioritized direction on the network
   specific:
      frame a question like ‘how to build a filter’ as an optimal path-finding problem on the network between some undefined starting component set & the destination filter object
      frame a question like ‘why would you build a filter’ as a adjacent object-finding problem to find objects that can be produced if the filter is the starting point (input) or to find intent directions moved in when you follows paths to build the filter (reasons to build it) or subsequent paths using the filter (other applications of the filter)
problem space analysis (analyzing a system composed of resources, agent intents, & problems)
   general: analyze whether the problem space changes in a way that invalidates the original or other problems once a particular solution is applied, anticipating cascading, self-sustaining & self-solving problems, and selecting between solutions
   specific: organize a set of resources into a problem space system with dimensions indicating primary factors of change that are also interfaces (as a foundation where changes can develop and be described in other embedded graphs) or cross-system attributes (like relevance), for standardized comparison of solution impact on all problems in the problem space system

The origin interface selection process may also output a interface sequence and/or an interface operation to map one interface to the other, combine them, or apply one to the other. The origin interface may also be in the form of a query across multiple interfaces. For example: ‘find the patterns of associated solutions for this problem type, and convert problem to patterns, and iterate through patterns, applying them one at a time to the problem pattern’.

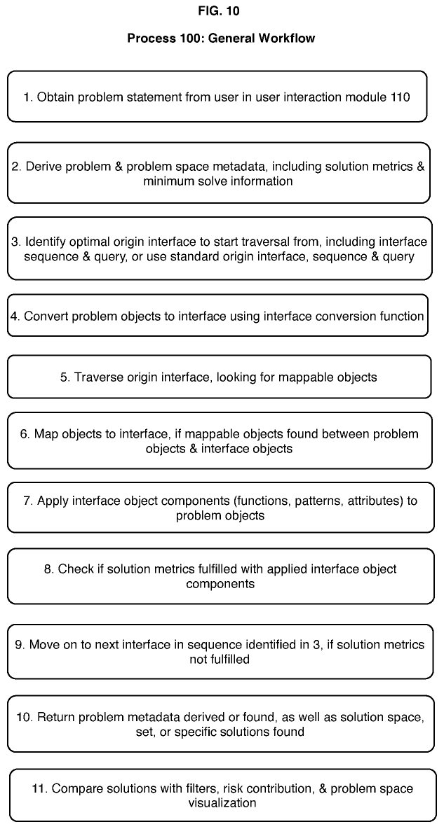

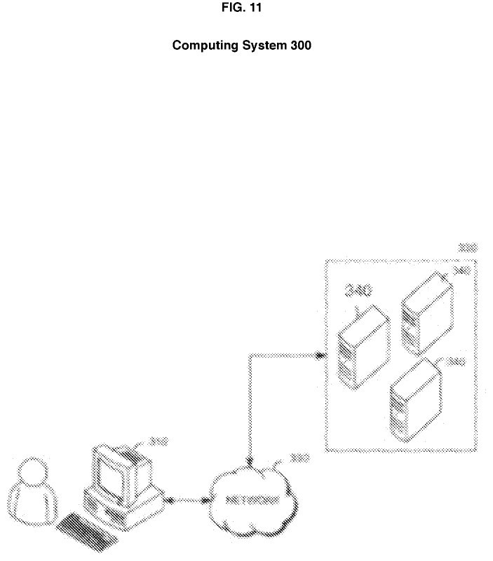

FIG. 10 illustrates a diagram of one embodiment of a process 100 of identifying possible solutions to a problem. The process 100 may be arranged in accordance with at least one embodiment described herein. One or more operations of the process 100 may be performed by a system or device, or combinations thereof, such as the system 100, the user interaction module 110, the machine learning system 120, the API finding/calling module 130, and/or the solution automation module 140 of FIG. 1, the computing system 300 of FIG. 11, etc. For illustrative purposes, various steps below will be identified as potentially being performed by one of the user interaction module 110, the machine learning system 120, the API finding/calling system 130, and/or the solution automation module 140 of FIG. 1. In these and other embodiments, the process 100 may be performed based on the execution of instructions stored on one or more non-transitory computer-readable media. Although illustrated as discrete steps, various steps of the process 100 may be divided into additional steps, combined into fewer steps, or eliminated, depending on the desired implementation.

Step 1. The problem statement is obtained from user in user interaction module 110, with optional filters such as the origin interface, inputs for known metadata like the problem type, and inputs for solution metrics like a certain object structure or an attribute value. In some embodiments, this step may also include checking the user input for validity, with regard to considerations like whether the input problem type matches the problem statement. If not, return an error message or correction suggestion to the user interaction module 110, so the user can edit the inputs & re-submit the form.

Step 2. If the inputs are valid, convert the problem statement to a concise form & derive problem metadata not specified by user, such as problem variables (such as agency involved in the problem, problem complexity, missing information, etc) optimal problem format, sub-problem types, required information to solve, solution metrics to filter successful solutions, definition of solution success, etc.

Step 3. Identify optimal origin interface to start traversal from (based on what information the user input or was derived in step 2, such as if it's a social problem, the best problem format is probably a system format, & starting traversal on the system interface to identify agent intents & incentives), optionally including:
interface sequence (such as start from the pattern interface if there isn't enough information & then convert to the system interface by fitting the patterns identified into a system)
query (such as ‘map the concept interface to the structural interface’).
   In some embodiments, this step may use a standard interface origin, sequence & query, if none are determinable from the problem statement—a standard interface origin, sequence & query which may be similar to: “start from origin system interface, checking for components fitting the object, attribute, & function interfaces (as well as structural interfaces & objects frequently found in systems like symmetries and equivalences), applying the insight interface where there is uncertainty and the pattern interface where the insight interface cannot reduce uncertainty”.

Step 4. Convert the problem object to the interface using the interface conversion function, so that the problem is framed in terms defined on the interface. For example, after converting a problem statement & problem object to the system interface, the problem should be framed as a network, so that it's easier to identify system objects within the problem such as conflicts. In some embodiments, this interface conversion function may act as a filter, isolating attributes of the problem that are specific to the interface, and may also convert the problem so that it's in a different format. This function may execute similar logic to the function to derive a definition of an object, logic which involves finding an alternate route (such as using the interface-specific terms) to output a set of attributes/functions (such as the problem object). In some embodiments, this step may add this error to a store of information generated/derived/found during traversal if the problem statement cannot be mapped to a particular interface, to be included in the output with the final solution metrics, for example “error: could not translate problem ‘create schedule’ to the attribute interface”) and skip to the next interface in the specified sequence. In some embodiments, this step may return to interface selection, sequence & query design at step 3, to translate the problem to a more standard interface (like the system or function or pattern interface), if there is no next interface & solution metrics are not fulfilled. In some embodiments, this step may return an error to be displayed on the user interaction module 110, if the problem is not translatable to any interface, optionally with a suggestion for additional information that could create a translatable problem that can be framed on an interface.

Step 5. The program traverses the interface, looking for mappable objects, attributes, and functions between the problem object and the interface objects. For example, once the program has formatted a problem as a system, iterate through objects, attributes, & functions in the problem system, checking for anything in the problem system that looks like a system object, such as a false similarity, an incentive, or an efficiency, with a particular focus on system objects that are associated with the problem type (if there are any insights relating that problem type with system objects such as imbalances relating to the info asymmetry problem type).

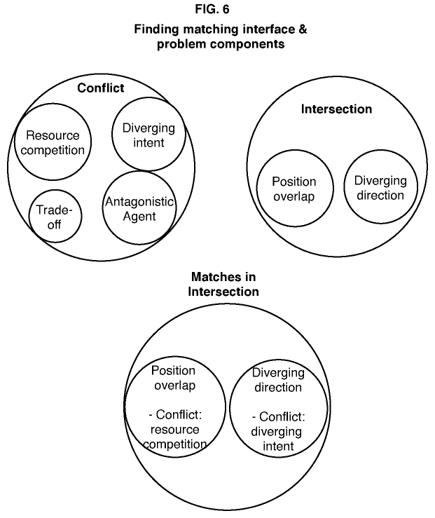

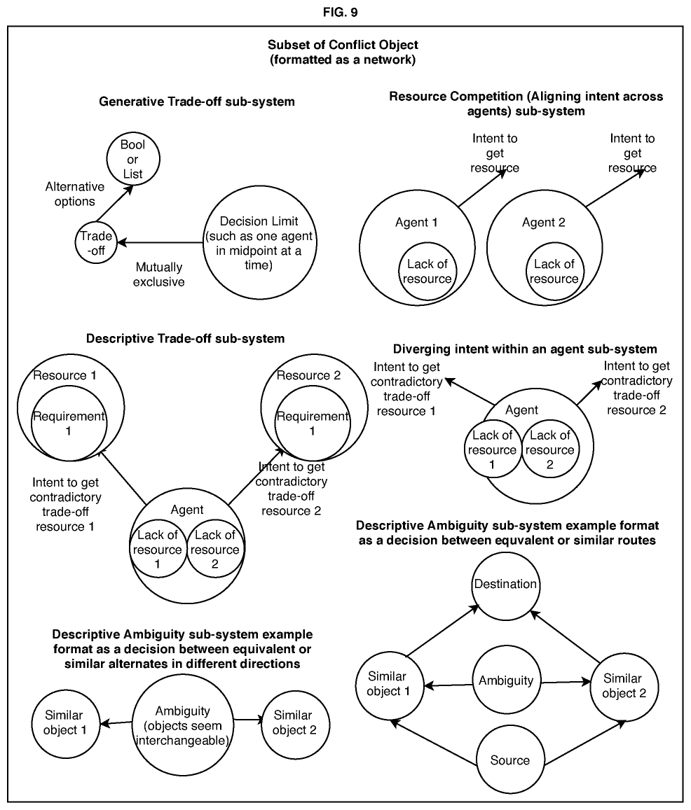

Step 6. If mappable objects are found between problem objects & interface objects, the program maps the problem to the interface by labeling the problem object & a degree of certainty in the identification, as well as the attributes/functions/objects found to be similar. For example, if while iterating through the problem system, the program finds a possible similarity between a problem system intersection object & a system conflict object (a similarity in shape or other attribute value), apply the ‘system conflict’ label to the problem system intersection object. FIG. 6 depicts an example of labeling a problem system object like an intersection with the possible matching object in the system interface (and a level of certainty added by each matching attribute/function) which is a conflict object, based on certain conflict attributes from its definition (shown in FIG. 9), like diverging intents and resource competition.

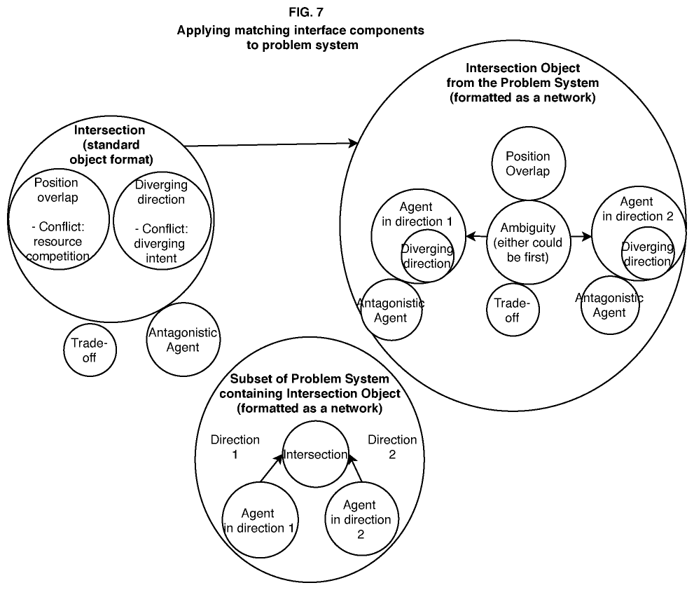

Step 7. The program applies interface object components (functions, patterns, attributes) to problem objects. For example, if the program finds a possible system conflict object in the problem system in step 6, apply the system conflict objects, functions, & attributes to the problem system intersection object, so if the system conflict object has an associated function in its definition like ‘diverging intents’ or ‘trade-off’ or ‘resource competition’ or ‘antagonistic agent’, apply those to the problem system intersection and see if they fit in the problem system intersection. An intersection is defined as “an overlap at the intersection point involving different directions”, so it's likely to match the ‘resource competition’ and ‘diverging intents’ components of the system conflict object definition, but may not depending on the problem definition (the intersection may just be an incidental routing object, rather than a competition for that position, and may allow multiple objects occupying the same position, and the directions may not indicate different intents if similar objects are in both directions). The program may follow this analysis with, for example, a query to the insight interface, applying any insight objects matched there to the problem system once the system objects were identified & applied. FIG. 7 depicts an example of applying interface object components to the problem object, where potential attributes/functions are included outside of objects and probable attributes/functions are contained in the objects. As shown in FIG. 7, now the intersection is formatted as a network, and the system objects like conflict (and its sub-components, patterns, objects, etc) have been applied to the intersection network. In the network format, position & other types of connections have semantic value. Now it's clearer that the intersection has an ambiguity in the position sequence attribute (a variant of the position overlap where only one agent can possess the resource at a given time), creating a possible conflict (determined by which agent arrives in the position first and which agent gets the position resource first). The diverging direction attribute inherent to the intersection has not been converted to a diverging intent, but it could be if the different directions indicate different intents, and if that difference is relevant to the resolution of the conflict about which agent is allowed in the position first. The mapping function has also identified a possible trade-off in the ambiguity, indicating that only one agent can occupy the position at a given time, so only one agent can go first (a scarce resource of occupation sequence or saved time that may be causative in the system, especially if the agent changes the intersection or removes some of its value by occupying it first).

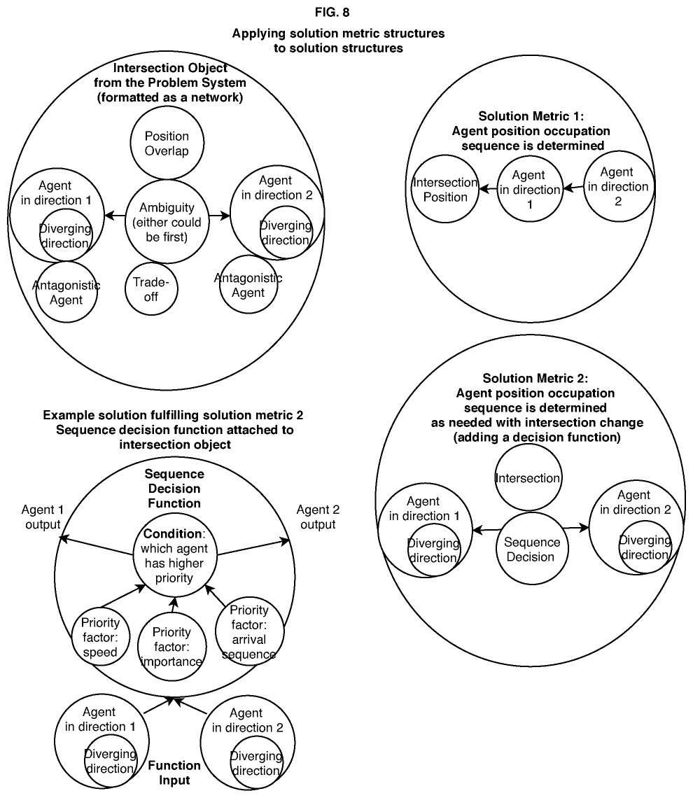

Step 8. The program checks if solution metrics are fulfilled with applied interface object components. Once the program formats the problem as a system, identifies system objects in the problem, & applies their objects, functions, & attributes, it checks for a clear way to solve the problem or whether other functionality needs to be applied. In some embodiments, this step may run processes like identifying all the objects like conflicts & incentives in the problem system & applying insights moving derived/generated/found information toward the minimum information to solve and/or fulfilling the solution metrics, then checking if there is a clear route or transformation that removes the problem as it was defined. For example, once the intersection object has had the system interface applied, checking if it's clear from the system interface application which agent should go first, or whether there is an optimization possible in the intersection that will invalidate the conflict of who goes first, or whether other functionality need to be applied, such as other conflict sub-systems such as finding substitutes of a resource (like an alternate route) to invalidate a conflict of the resource competition sub-type. As shown in FIG. 8, this step identifies whether the output of step 7 creates information that is easily transformed into the solution metric, given the relevant objects/attributes/functions of the solution metric. Is it clear which agent goes first, or whether the intersection can be changed in a way that determines which agent goes first? If the solution metric 1 is fulfilled, the agents have no antagonistic agent attribute & there is no trade-off because no variance from a decision is allowed at the intersection. If the solution metric 2 is fulfilled, the intersection loses its position overlap attribute & the diverging direction attribute doesn't matter anymore, but it does have a decision function at the intersection. If the intersection object with the system interface is applied can be easily transformed into having one of the solution metrics fulfilled, that transformation can be considered a possible solution.

Step 9. If solution metrics are not fulfilled, the program moves on to next interface in sequence identified in step 3 if there is one, and iterates through steps 3-7 as needed to execute functions like adjusting interface sequence or query, converting objects to the interface, finding similar objects between the problem & interface, applying interface objects, & checking if the solution metrics are fulfilled by that application. In some embodiments, this step may return to interface selection, sequence & query design at step 3, to translate the problem to a more standard interface (like the system or function or pattern interface), if there is no next interface in the sequence/query. In some embodiments, this step may check if the standard interface origin/sequence/query have been applied already, and if there is also no next interface in the sequence, it may skip further traversals & return any information generated/derived/found, including the processes tried & results, to the user interaction module 110.

Step 10. The program may return problem metadata derived or found, as well as solution space, solution set, or specific optimal solutions found, either ranked or as comparable alternatives or otherwise formatted. For a prediction problem, this may mean returning the function definition if a specific optimal function (solution) was found, or the function & variants with varying bias or other error metrics optimized (solution set), or a range of functions (solution space). In some embodiments, this step may also include output such as:
input filters
risk contributed by input filters
risk contributed by traversals (using a pattern instead of an insight contributes risk)
solution(s) and/or solution space
solution implementation steps
solution components
visualization of solution impact on problem space
set of queries used to generate/find/derive solutions
methods to generate optimizations of those queries which the system will store for any future users with a similar problem
other solution information, like solution statistics, success probability, ratio of patterns to insights used in the solution, etc.
any non-fatal errors encountered, such as missing optional information or components, or patterns/predictions made in the absence of clarity
any problem space information derived during the traversal, such as identified possible/probable insights, questions, strategies, patterns, causes, etc.

Step 11. The program may compare & evaluate solutions, visualize problem space, describe solution steps & traversals to generate them, and optimize the traversal & program execution, in the user interaction interface 110. This step involves listing some processes & components used as well as interim information derived during the traversal(s), and errors found or risk contributed by processing. In some embodiments, this step may also involve calculating some solution statistics given stored information in the database such as information about previous queries or feedback on solutions entered by user on returning to the solution output in the user interaction module (stored as its own problem output report & accessible with the user interaction module). In some embodiments, this step may also allow the user to edit the problem space visualization component & examine the impact of other solutions, drill down into embedded object graphs in the problem space, move or otherwise change problem objects, & adjust displayed dimensions of the space like intent, which may trigger an execution of the problem definition, interface conversion & traversal process depending on the edits made. In some embodiments, this step may also allow the user to download solution steps, optimize the system or the traversal (skipping unnecessary nodes & so on), examine the queries that generated the solution, review the risk contributed by each filter or pattern or other risky object depended on by the solution or solution generation process, & execute other actions on the output information. After a solution has been generated/derived/found by the program, the program may include a secondary workflow involving an edit to the solution output. In some embodiments, as the edit may optionally involve an edit to the problem space visualization, the edit may trigger a function to evaluate if a re-calculation of the solution is necessary, or if problem space visualization logic or solution output is sufficient to handle the edit (such as removing a dimension of the visualization). In some embodiments, if the re-calculation function is called & determines that no re-calculation is necessary, the solution output is adjusted according to the edit. In some embodiments, if the re-calculation function is called & determines that a re-calculation is necessary, the logic flow calls a function to determine where to start re-calculating. In some embodiments, determines if the edit requires returning to step 2 to re-define the problem definition, step 3 to execute interface selection, sequence & query design, or step 4 to convert to the same interface or a standard interface and execute the traversal generating the solution output. As shown in FIG. 5, this step can involve user edits to the problem space visualization component of the user interface module 110, including edits like changing the position or other attributes of problem objects & their attributes/functions, applying different solutions in the solution set, changing the dimensions of the problem space. When the user edits the problem space visualization, the changes are sent to step 2 or later (depending on whether adjustment of the problem definition or conversion to the interface needs to be done & so on), where the calculations are executed to return the output of the new impact those edits would have on the problem space.

One skilled in the art, after reviewing this disclosure, may recognize that modifications, additions, or omissions may be made to the process 100 without departing from the scope of the disclosure. For example, the operations of the process 100 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 11 illustrates an example computing system 300 for solving a problem with a solution automation module, according to at least one embodiment described in the present disclosure. The computing system 300 may include a processor 310, a memory 320, a data storage 330, and/or a communication unit 340, which all may be communicatively coupled. Any or all of the system 100 of FIG. 1 may be implemented as a computing system consistent with the computing system 300. For example, the user interaction module 110, the machine learning system 120, the API finding & calling system 130, and the solution automation module 140 may be implemented together as a single computing system. As another example, the machine learning system 120 and the API finding & calling system 130 may be implemented as one computing system while the solution automation module 140 and the user interaction module 110 may be implemented as a separate computing system. As an additional example, the machine learning system 120 may be implemented as one computing system, the API finding & calling system 130 may be implemented as another computing system, the solution automation module 140 may be implemented as another computing system, and the user interaction module 110 may be implemented as an additional computing system. In these and other embodiments, the computing system 300 may be a specialized computing system configured to perform specific and non-conventional operations, such as those identified in FIG. 10.

Generally, the processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 11, it is understood that the processor 310 may include any number of processors distributed across any number of network or physical locations that are configured to perform individually or collectively any number of operations described in the present disclosure. In some embodiments, the processor 310 may interpret and/or execute program instructions and/or process data stored in the memory 320, the data storage 330, or the memory 320 and the data storage 330. In some embodiments, the processor 310 may fetch program instructions from the data storage 330 and load the program instructions into the memory 320.

After the program instructions are loaded into the memory 320, the processor 310 may execute the program instructions, such as instructions to perform the process 100 of FIG. 10. For example, the processor 310 may obtain instructions regarding solving a problem with a solution automation module, and generating a solution for the problem statement. As another example, the processor 310 may analyze user changes to outputs filtering, describing or analyzing the solution, solution space, problem space, or problem statement, and determine the success of a solution based on those changes to outputs.

The memory 320 and the data storage 330 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 310. In some embodiments, the computing system 300 may or may not include either of the memory 320 and the data storage 330.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 340 may include any component, device, system, or combination thereof that is configured to transmit or receive information over a network. In some embodiments, the communication unit 340 may communicate with other devices at other locations, the same location, or even other components within the same system. For example, the communication unit 340 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 340 may permit data to be exchanged with a network and/or any other devices or systems described in the present disclosure. For example, the communication unit 340 may allow the system 300 to communicate with other systems, such as computing devices and/or other networks.

One skill in the art, after reviewing this disclosure, may recognize that modifications, additions, or omissions may be made to the system 300 without departing from the scope of the present disclosure. For example, the system 300 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method comprising: obtaining a problem statement from a user including required solution metrics (such as priorities, functionality, or attributes); identifying problem & problem space metadata (such as problem type & minimum information required to solve the problem); identifying optimal origin interface to start traversing from, interface traversal sequence, & applying interface operations like combine/inject; traversing interface network (including interfaces such as information, insight, structure, math, concept, variance, potential, change, intent, perspective, system, attribute, pattern, function, cause, problem/question, solution/answer) of interfaces acting as filters (where an interface is comprised of its definition routes, conversion function, core functions, objects, & attributes, and related objects like patterns & metadata specific to the interface) starting at the origin interface; finding components on the interface that match the problem structures (including related objects like insights, patterns, & functions); compressing the problem statement into its most accurate structure containing the found interface objects; iterating the origin interface selection & interface traversal process for the solution space; identifying & reducing the solution space from this standardized problem format; traversing subsequent interfaces to obtain additional information; reducing the solution space by the problem & problem space definition; returning the identified optimal solution as a set of steps to compress the problem as well as solution metrics, attributes, & actions, and/or insights/patterns/system/standardized description related to the problem if no solutions are found.

2. The method of claim 1, wherein obtaining a problem statement includes: receiving a problem statement & translating the problem statement into its most standardized form, using standardization methods like replacing esoteric words with more common synonyms, converting passive to active language, and removing words that don't change the meaning of the statement.

3. The method of claim 1, wherein identifying the problem & problem space metadata includes: identifying the problem type given the most adjacent type (such as an information asymmetry, incentive conflict, unenforced rule, finding a prediction function, route optimization) and the minimum information required to solve the problem (inputs like alternate attribute sets; solution requirements; constant assumptions & other dependencies), then mapping the inferred or stated assumptions describing the problem space to a multi-dimensional structure, usually bounded by assumption limit or filter conditions, & indicating possible interactions between the problem objects & the other system objects, & containing the problem object in that space (as a network or other shape indicating the problem variable interactions within the problem space structure).

4. The method of claim 1, wherein identifying the origin interface to start traversing from, interface traversal sequence, & applying interface operations like combine/inject includes: assessing which interface maximizes the value (calculated as a combination of metrics like specificity, uniqueness, differentiation potential) of the given & directly inferable information, which interfaces should be traversed in what sequence, and whether interfaces should be applied to other interfaces with interface operations (applying the conceptual interface to the structural interface for example).

5. The method of claim 1, wherein traversing the interface network includes: converting the problem definition to the interface using the conversion function which applies system-mapping, position-finding, & object-fitting logic, & looks for common attributes between problem objects & interface objects & their structures (like transformations, subsets, & paths) so that interface object relationships can be used to infer relationships about associated problem objects, where the traversal may start from various points on the interface, including core objects & functions, or directly mappable objects to the problem objects, or important or required interface objects.

6. The method of claim 1, further comprising iteratively repeating the traversal method on other interfaces, given the achieved distance from the minimum information required to solve the problem, fulfilled solution requirements, & progress in compressing the problem, where information output by each traversal may include information, interface objects, functions, or attributes compressing the problem.

7. The method of claim 1, wherein the solution metadata is identified & the interface network traversal process is repeated for reducing the problem space to a solution space & then deriving, finding, matching, applying, or building a specific solution or general solution method that compresses the problem into a form that is more adjacent to its final solved form (occupying a point rather than a multi-dimensional structure in the problem space definition), where the solution method may be executed on other interfaces and is then converted to a vector or other object impacting the formatted problem on an interim interface used for calculations, and is then converted to an object impacting the original problem in the problem space structure.

8. The method of claim 1, wherein the matching of a problem and a solution is done with various interface traversals, potentially determined by the selected origin of the traversal, problem & solution definitions & associated space definitions, including system analysis (fitting of system objects like symmetries, sub-systems, sub-interfaces, false assumptions, correlations, and conflicts to problem definition); information problem type composition (mapping the problem as a combination/set/path containing information problem types like an information mismatch or inequality or minimum or overflow or lack); insight path application (using insight paths from other fields to optimize insight generation); problem vectorization (mapping the problem definition to a one-directional tree with inputs on one side, interim inferred important problem concepts in between, and target priorities or attributes on the other, linked by available functions); concept-structure application (a multi-interface traversal linking the concept & structure interfaces, so a target concept combination/set/path or target structural attribute can be achieved with a combination of filters & limits or functions applied to adjust the structure until it matches the target structural attributes or concepts); a pattern interface traversal (where patterns replace missing required data, such as patterns between variables of specific types or system positions to infer their probable relationship); a causal interface traversal (where the problem structures are matched to causal structures to infer probable causation metadata like directness of cause, degree of cause, inevitability, uniqueness of cause, causal tree/network/loop/layer shape); structure-math mapping (a multi-interface traversal to map problem structures to math objects to apply math insights to problem structures); a question-answer interface traversal (where a question is framed as a source position and a target position on a network, and the answer is the most robust path or the path that moves the nearest to the target position or the path that moves in the priority direction on the network); problem space analysis (given whether the problem space changes in a way that invalidates the original or other problems once a particular solution is applied).

9. The method of claim 1, further comprising determining the success of a particular solution, given the solution requirements stated or inferred from the problem statement & iterating if solution requirements are not met, or if the problem is not fully compressed, or if the solution created other problems in the problem space.

10. A non-transitory computer-readable medium containing instructions that, when executed by a processor, cause a device to perform operations, the operations comprising: obtaining a problem statement from a user including required solution metrics (such as priorities, functionality, or attributes); identifying problem & problem space metadata (such as problem type & minimum information required to solve the problem); identifying optimal origin interface to start traversing from, interface traversal sequence, & applying interface operations like combine/inject; traversing interface network (including interfaces such as information, insight, structure, math, concept, type, variance, potential, change, intent, perspective, system, attribute, pattern, function, cause, problem/question, solution/answer) of interfaces acting as filters (where an interface is comprised of its definition routes, conversion function, core functions, objects, & attributes, and related objects like patterns & metadata specific to the interface) starting at the origin interface; finding components on the interface that match the problem structures (including related objects like insights, patterns, & functions); compressing the problem statement into its most accurate structure containing the found interface objects; iterating the origin interface selection & interface traversal process for the solution space; identifying & reducing the solution space from this standardized problem format; traversing subsequent interfaces to obtain additional information; reducing the solution space by the problem & problem space definition; returning the identified optimal solution as a set of steps to compress the problem as well as solution metrics, attributes, & actions, and/or insights/patterns/system/standardized description related to the problem if no solutions are found.

11. The non-transitory computer-readable medium of claim 10, wherein obtaining a problem statement includes: receiving a problem statement & translating the problem statement into its most standardized form, using standardization methods like replacing esoteric words with more common synonyms, converting passive to active language, and removing words that don't change the meaning of the statement.

12. The non-transitory computer-readable medium of claim 10, wherein identifying the problem & problem space metadata includes: identifying the problem type given the most adjacent type (such as an information asymmetry, incentive conflict, unenforced rule, finding a prediction function, route optimization) and the minimum information required to solve the problem (inputs like alternate attribute sets; solution requirements; constant assumptions & other dependencies), then mapping the inferred or stated assumptions describing the problem space to a multi-dimensional structure, usually bounded by assumption limit or filter conditions, & indicating possible interactions between the problem objects & the other system objects, & containing the problem object in that space (as a network or other shape indicating the problem variable interactions within the problem space structure).

13. The non-transitory computer-readable medium of claim 10, wherein identifying the origin interface to start traversing from, interface traversal sequence, & applying interface operations like combine/inject includes: assessing which interface maximizes the value (calculated as a combination of metrics like specificity, uniqueness, differentiation potential) of the given & directly inferable information, which interfaces should be traversed in what sequence, and whether interfaces should be applied to other interfaces with interface operations (applying the conceptual interface to the structural interface for example).

14. The non-transitory computer-readable medium of claim 10, wherein traversing the interface network includes: converting the problem definition to the interface using the conversion function which applies system-mapping, position-finding, & object-fitting logic, & looks for common attributes between problem objects & interface objects & their structures (like transformations, subsets, & paths) so that interface object relationships can be used to infer relationships about associated problem objects, where the traversal may start from various points on the interface, including core objects & functions, or directly mappable objects to the problem objects, or important or required interface objects.

15. The non-transitory computer-readable medium of claim 10, wherein the instructions are further configured to iteratively repeat the traversal method on other interfaces, given the achieved distance from the minimum information required to solve the problem, fulfilled solution requirements, & progress in compressing the problem, where information output by each traversal may include information, interface objects, functions, or attributes compressing the problem.

16. The non-transitory computer-readable medium of claim 10, wherein the solution metadata is identified & the interface network traversal process is repeated for reducing the problem space to a solution space & then deriving, finding, matching, applying, or building a specific solution or general solution method that compresses the problem into a form that is more adjacent to its final solved form (occupying a point rather than a multi-dimensional structure in the problem space definition), where the solution method may be executed on other interfaces and is then converted to a vector or other object impacting the formatted problem on an interim interface used for calculations, and is then converted to an object impacting the original problem in the problem space structure.

17. The non-transitory computer-readable medium of claim 10, wherein the matching of a problem and a solution is done with various interface traversals, potentially determined by the selected origin of the traversal, problem & solution definitions & associated space definitions, including system analysis (fitting of system objects like symmetries, sub-systems, sub-interfaces, false assumptions, correlations, and conflicts to problem definition); information problem type composition (mapping the problem as a combination/set/path containing information problem types like an information mismatch or inequality or minimum or overflow or lack); insight path application (using insight paths from other fields to optimize insight generation); problem vectorization (mapping the problem definition to a one-directional tree with inputs on one side, interim inferred important problem concepts in between, and target priorities or attributes on the other, linked by available functions); concept-structure application (a multi-interface traversal linking the concept & structure interfaces, so a target concept combination/set/path or target structural attribute can be achieved with a combination of filters & limits or functions applied to adjust the structure until it matches the target structural attributes or concepts); a pattern interface traversal (where patterns replace missing required data, such as patterns between variables of specific types or system positions to infer their probable relationship); a causal interface traversal (where the problem structures are matched to causal structures to infer probable causation metadata like directness of cause, degree of cause, inevitability, uniqueness of cause, causal tree/network/loop/layer shape); structure-math mapping (a multi-interface traversal to map problem structures to math objects to apply math insights to problem structures); a question-answer interface traversal (where a question is framed as a source position and a target position on a network, and the answer is the most robust path or the path that moves the nearest to the target position or the path that moves in the priority direction on the network); problem space analysis (given whether the problem space changes in a way that invalidates the original or other problems once a particular solution is applied).

18. The non-transitory computer-readable medium of claim 10, the operations further comprising determining the success of a particular solution, given the solution requirements stated or inferred from the problem statement & iterating if solution requirements are not met, or if the problem is not fully compressed, or if the solution created other problems in the problem space.

19. A system comprising: one or more processors; and one or more non-transitory computer-readable media containing instructions that, when executed by the one or more processors, cause the system to perform operations, the operations comprising: obtaining a problem statement from a user including required solution metrics (such as priorities, functionality, or attributes); identifying problem & problem space metadata (such as problem type & minimum information required to solve the problem); identifying optimal origin interface to start traversing from, interface traversal sequence, & applying interface operations like combine/inject; traversing interface network (including interfaces such as information, insight, structure, math, concept, type, variance, potential, change, intent, perspective, system, attribute, pattern, function, cause, problem/question, solution/answer) of interfaces acting as filters (where an interface is comprised of its definition routes, conversion function, core functions, objects, & attributes, and related objects like patterns & metadata specific to the interface) starting at the origin interface; finding components on the interface that match the problem structures (including related objects like insights, patterns, & functions); compressing the problem statement into its most accurate structure containing the found interface objects; iterating the origin interface selection & interface traversal process for the solution space; identifying & reducing the solution space from this standardized problem format; traversing subsequent interfaces to obtain additional information; reducing the solution space by the problem & problem space definition; returning the identified optimal solution as a set of steps to compress the problem as well as solution metrics, attributes, & actions, and/or insights/patterns/system/standardized description related to the problem if no solutions are found.

20. The system of claim 19, wherein obtaining a problem statement includes: receiving a problem statement & translating the problem statement into its most standardized form, using standardization methods like replacing esoteric words with more common synonyms,
converting passive to active language, and removing words that don't change the meaning of the statement.

21. The system of claim 19, wherein identifying the problem & problem space metadata includes: identifying the problem type given the most adjacent type (such as an information asymmetry, incentive conflict, unenforced rule, finding a prediction function, route optimization) and the minimum information required to solve the problem (inputs like alternate attribute sets; solution requirements; constant assumptions & other dependencies), then mapping the inferred or stated assumptions describing the problem space to a multi-dimensional structure, usually bounded by assumption limit or filter conditions, & indicating possible interactions between the problem objects & the other system objects, & containing the problem object in that space (as a network or other shape indicating the problem variable interactions within the problem space structure).

22. The system of claim 19, wherein identifying the origin interface to start traversing from, interface traversal sequence, & applying interface operations like combine/inject includes: assessing which interface maximizes the value (calculated as a combination of metrics like specificity, uniqueness, differentiation potential) of the given & directly inferable information, which interfaces should be traversed in what sequence, and whether interfaces should be applied to other interfaces with interface operations (applying the conceptual interface to the structural interface for example).

23. The system of claim 19, wherein traversing the interface network includes: converting the problem definition to the interface using the conversion function which applies system-mapping, position-finding, & object-fitting logic, & looks for common attributes between problem objects & interface objects & their structures (like transformations, subsets, & paths) so that interface object relationships can be used to infer relationships about associated problem objects, where the traversal may start from various points on the interface, including core objects & functions, or directly mappable objects to the problem objects, or important or required interface objects.

24. The system of claim 19, further comprising iteratively repeating the traversal method on other interfaces, given the achieved distance from the minimum information required to solve the problem, fulfilled solution requirements, & progress in compressing the problem, where information output by each traversal may include information, interface objects, functions, or attributes compressing the problem.

25. The system of claim 19, wherein the solution metadata is identified & the interface network traversal process is repeated for reducing the problem space to a solution space & then deriving, finding, matching, applying, or building a specific solution or general solution method that compresses the problem into a form that is more adjacent to its final solved form (occupying a point rather than a multi-dimensional structure in the problem space definition), where the solution method may be executed on other interfaces and is then converted to a vector or other object impacting the formatted problem on an interim interface used for calculations, and is then converted to an object impacting the original problem in the problem space structure.

26. The system of claim 19, wherein the matching of a problem and a solution is done with various interface traversals, potentially determined by the selected origin of the traversal, problem & solution definitions & associated space definitions, including system analysis (fitting of system objects like symmetries, sub-systems, sub-interfaces, false assumptions, correlations, and conflicts to problem definition); information problem type composition (mapping the problem as a combination/set/path containing information problem types like an information mismatch or inequality or minimum or overflow or lack); insight path application (using insight paths from other fields to optimize insight generation); problem vectorization (mapping the problem definition to a one-directional tree with inputs on one side, interim inferred important problem concepts in between, and target priorities or attributes on the other, linked by available functions); concept-structure application (a multi-interface traversal linking the concept & structure interfaces, so a target concept combination/set/path or target structural attribute can be achieved with a combination of filters & limits or functions applied to adjust the structure until it matches the target structural attributes or concepts); a pattern interface traversal (where patterns replace missing required data, such as patterns between variables of specific types or system positions to infer their probable relationship); a causal interface traversal (where the problem structures are matched to causal structures to infer probable causation metadata like directness of cause, degree of cause, inevitability, uniqueness of cause, causal tree/network/loop/layer shape); structure-math mapping (a multi-interface traversal to map problem structures to math objects to apply math insights to problem structures); a question-answer interface traversal (where a question is framed as a source position and a target position on a network, and the answer is the most robust path or the path that moves the nearest to the target position or the path that moves in the priority direction on the network); problem space analysis (given whether the problem space changes in a way that invalidates the original or other problems once a particular solution is applied).

27. The system of claim 19, further comprising determining the success of a particular solution, given the solution requirements stated or inferred from the problem statement & iterating if solution requirements are not met, or if the problem is not fully compressed, or if the solution created other problems in the problem space.
